(19) United States
(12) Patent Application Publication
(10) Pub. No.: US 2009/0304088 A1
(43) Pub. Date: Dec. 10, 2009

(54) VIDEO-SOUND SIGNAL PROCESSING SYSTEM

(75) Inventor: Takeshi KODAKA, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/431,907

(22) Filed: Apr. 29, 2009

(30) Foreign Application Priority Data
Jun. 4, 2008 (JP) 2008-147375

(51) Int. Cl. H04N 11/02

(52) U.S. Cl. 375/240.25; 375/E07.027

(57) ABSTRACT

A video-sound signal processing system is provided with a video decoder and sound decoder. The video decoder outputs a decoded image signal and decoding information. The sound decoder outputs decoded sound signal. Scene change between preceding and current video scenes is detected in a video scene change detection unit, on the basis of the decoding information. A characteristic of the current video scene is judged based on the decoded image signal and output from the video scene change detection unit. Sound field control information is generated to control sound field suiting to the current video scene, according to the characteristic of the current video scene judged, in a sound field control information generation unit. A sound field adjustment unit adjusts sound field of a sound based on the decoded sound signal which is outputted from the sound decoder, using the sound field control information.

### CROSS REFERENCE TO RELATED APPLICATION

This application is based upon and claims the benefit of priority from the prior Japanese Patent Application No. 2008-147375, filed on Jun. 4, 2008, the entire contents of which are incorporated herein by reference.

### FIELD OF THE INVENTION

The invention relates to a video-sound signal processing system to obtain video output and sound output based on a coded video stream and a coded sound stream.

### DESCRIPTION OF THE BACKGROUND

Moving image contents may be transmitted through digital television broadcasting or an online system, or may be stored in a medium such as a DVD. Such contents have a stream data format where compressed and coded image data and sound data including voice data are multiplexed.

The stream data may be inputted to a video-sound signal processing system. The inputted stream data is separated to a video stream and a sound stream by a multiple-signal separation unit (hereinafter, referred to as “Demux”) provided in a video-sound signal processing system.

After the separation, the video stream is decoded by a video decoder. An image signal obtained by the decoding is image-adjusted by a video filter to output to a video output device. The image-adjusted image signal is converted to an image in the video output device.

On the other hand, the sound stream separated by the multiple-signal separation unit is decoded by a sound decoder. A sound signal obtained by the decoding is sound-adjusted by a sound filter to output to a sound output device. The sound-adjusted signal is converted to a sound in the sound output device.

The video and the sound may be obtained by performing the conversion of the video and sound signals after processing the same, as well as by performing conversion of the signals directly.

In Japanese Patent Application Publication No. 2005-109925, pages 3, 4 and FIG. 1, a digital broadcast receiver is disclosed. The digital broadcast receiver emphasizes subtitle output and sound output simultaneously to notify a user of scene change when a specific scene suiting the liking of the user is broadcasted.

A demand of a user that wishes to avoid missing a desired scene may be satisfied by the digital broadcast receiver.

Another demand of the user is to adjust sound to a sound being suited to a corresponding image, in accordance with a video scene, automatically. For example, there is a demand of adjusting a sound automatically so as to catch conversation of performers easily in a scene of a talk program where they talk each other.

However, subtitle output and sound output are only emphasized according to a scene change, and sound cannot be adjusted corresponding to the scene change, in the digital broadcast receiver.

### SUMMARY OF THE INVENTION

An aspect of the present invention provides a video-sound signal processing system, which includes a video decoder to decode a coded video stream, the video decoder outputting a decoded image signal and decoding information, a sound decoder to decode a coded sound stream, the sound decoder outputting a decoded sound signal, a video scene change detection unit to detect scene change between preceding and current video scenes on the basis of the decoding information obtained from the video decoder when the coded video stream is decoded by the video decoder, a video scene characteristic judging unit to judge a characteristic of the current video scene from the decoded image signal outputted from the video decoder when starting of the current video scene is detected by the video scene change detection unit, a sound field control information generation unit to generate sound field control information to control a sound field suiting to the current video scene according to the characteristic of the current video scene judged by the video scene characteristic judging unit, and a sound field adjustment unit to adjust sound field of a sound based on the decoded sound signal outputted from the sound decoder, using the sound field control information outputted from the sound field control information generation unit.

Another aspect of the present invention provides a video-sound signal processing system, which includes a video decoder to decode a coded video stream, the video decoder outputting a decoded image signal and decoding information, a sound decoder to decode a coded sound stream, the sound decoder outputting a decoded sound signal, a video scene change detection unit to detect scene change between preceding and current video scenes on the basis of the decoding information obtained from the video decoder when the coded video stream is decoded by the video decoder, a video scene characteristic judging unit to judge whether talking exists or not from the decoded image signal outputted from the video decoder, when starting of the current video scene is detected by the video scene change detection unit, the video scene characteristic judging unit including a face detection portion and a talking detection portion, the face detection portion detecting a face of a person from the decoded image signal, further the talking detection portion detecting a movement of a mouth of the person from information of the face detected by the face detection portion for the judgment, a sound field control information generation unit to generate sound field control information to control a sound field to suit to the current video scene according to the judgment of existence of talking by the video scene characteristic judging unit, and a sound field adjustment unit to adjust the sound field of the sound the person corresponding the decoded sound signal outputted from the sound decoder, on the basis of the sound field control information outputted from the sound field control information generation unit.

Further another aspect of the present invention provides a video-sound signal processing system, which includes a video decoder to decode a coded video stream, the video decoder outputting a decoded image signal and decoding information, a sound decoder to decode a coded sound stream, the sound decoder outputting a decoded sound signal, a video scene change detection unit to detect scene change between preceding and current video scenes on the basis of the decoding information obtained from the video decoder when the coded video stream is decoded by the video decoder, a video scene characteristic judging unit to detect a moving body from the decoded image signal outputted from the video decoder when starting of the current video scene is detected by the video scene change detection unit, the video scene characteristic judging unit including a moving body detection portion and a position information generation portion, the moving body detection portion detecting the moving body from the decoded image signal to generates information of the moving body, further the position information generation portion generating position information of the moving body on the basis of moving vector data being included in the decoded image signal outputted from the video decoder when the moving body detection portion detects the moving body, a sound field control information generation unit to generate sound field control information to control sound field to suit to the current video scene according to the information of the moving body and the position information of the moving body, and a sound field adjustment unit to adjust the sound field of the sound corresponding to the decoded sound signal outputted from the sound decoder, on the basis of the sound field control information outputted from the sound field control information generation unit.

### BRIEF DESCRIPTION OF THE DRAWINGS

FIG. 1 is a block diagram showing a video-sound signal processing system according to a first embodiment of the invention.

FIG. 2 is a block diagram showing a video-sound signal processing system according to a second embodiment of the invention.

### DETAILED DESCRIPTION OF THE INVENTION

Hereinafter, embodiments of the invention will be described with reference to the drawings.

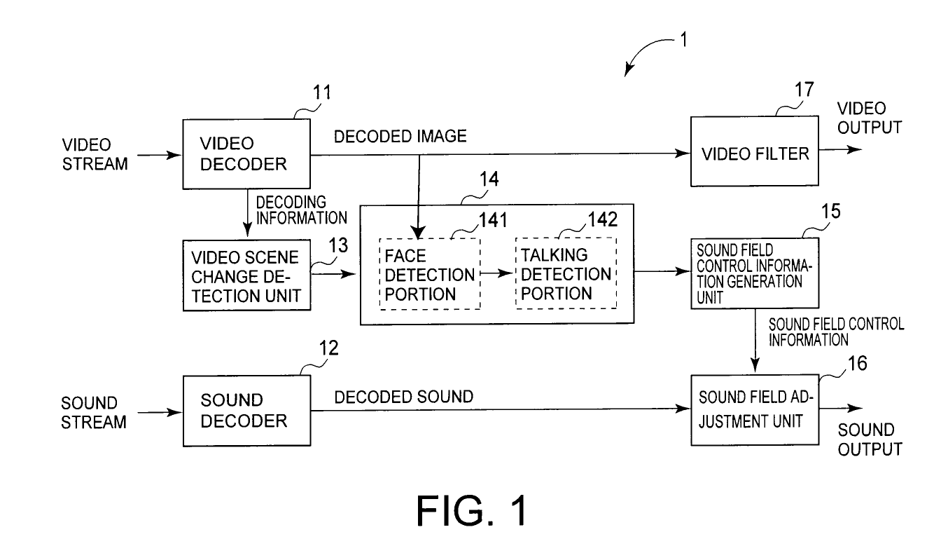

A first embodiment of a video-sound signal processing system of the present invention will be explained with reference to FIG. 1. FIG. 1 is a block diagram showing the configuration of the first embodiment of the video-sound signal processing system according to the invention.

In the embodiment, contents, which show a situation of conversation of performers in a talk program, are used as video-sound contents. In the contents, postures of the performers, particularly, postures of their faces mainly, are included in an image, while voices of the performers are included mainly as sounds. The image is a moving image or a still image.

The video-sound signal processing system of the embodiment adjusts a sound signal so as to catch the conversation of the performers easily, when a video stream and a sound stream of the video-sound contents are inputted. The video-sound signal processing system outputs the adjusted sound signal to a sound outputting device.

As shown in FIG. 1, a video-sound signal processing system 1 is provided with a video decoder 11 and a sound decoder 12. The video decoder 11 decodes an inputted coded video stream. The sound decoder 12 decodes an inputted coded sound stream.

The decoded image signal, which is outputted from the video decoder 11, is provided to a video filter 17 to perform a predetermined filtering process. From the video filter 17, a video output subjected to the filtering process is obtained.

Decoding information relating to scene change, which is obtained from the video decoder 11 during decoding the coded video stream, is provided to a video scene change detection unit 13.

The decoding information is information being contained in the video stream before decoding or information being acquired while decoding the video stream. The decoding information is information relating to image, as well, which is read out from the video stream when the video stream is decoded to obtain the decoded image signal.

Further, the decoding information is such information as the information indicating that the picture type of the image is I type or the information indicating that moving vector value varies for each macro-block of the video stream, which are specified in the moving picture image compression-coding standard H.264, respectively, for example.

The video scene change detection unit 13 detects change between preceding and current video scenes on the basis of the decoding information. A signal obtained from the video scene change detection unit 13 and the decoded image signal obtained from the video decoder 11 are inputted to a video scene characteristic judging unit 14. The video scene characteristic judging unit 14 judges the characteristic of the video scene based on the decoded image signal, when starting of the current video scene is detected by the video scene change detection unit 13.

The output of the video scene characteristic judging unit 14 is inputted to a sound field control information generation unit 15. The sound field control information generation unit 15 generates sound field control information which is sound filter information to control to a sound field suiting to the current video scene, according to the characteristic of the video scene judged by the video scene characteristic judging unit 14. The sound field control information, which is outputted from the sound field control information generation unit 15, is provided to a sound field adjustment unit 16. The sound field adjustment unit 16 adjusts sound field of a sound based on the decoded sound signal which is outputted from the sound decoder 12. An adjusted sound output is obtained from the sound field adjustment unit 16.

The video-sound signal processing system 1 judges whether an updated video scene is a conversation scene of performers or not, whenever scene change occurs. The scene change is detected by the video scene change detection unit 13.

The video scene characteristic judging unit 14 includes a face detection portion 141 and a talking detection portion 142.

The face detection portion 141 detects a face of one of the performers from the decoded image signal outputted from the video decoder 11. The talking detection portion 142 detects movement of the mouth of the one of the performers from the face information detected by the face detection portion 141. The talking detection portion 142 judges whether the one of the performer is talking or not.

The face detection portion 141 detects whether the face of the one of the performer is included in the decoded image or not, using a well-known face recognition technology.

The talking detection portion 142 observes the movement of the mouth portion of the face detected by the face detection portion 141. The talking detection portion 142 judges that the face detected by the face detection portion 141 is talking, if the mouth shows the movement of the mouth such as opening and closing.

The video scene characteristic judging unit 14 judges that the characteristic of the current video scene is a scene of conversation by the performers, if the talking detection portion 142 detects talking.

The sound field control information generation unit 15 generates sound filter information of the frequency characteristic suiting to listening to the conversation, as sound field control information, when the video scene characteristic judging unit 14 judges as the scene of the conversation by the performers.

The sound field adjustment unit 16 sets a frequency characteristic of a sound filter provided in the sound field adjustment unit 16 according to the sound control information that is sound filter information from the sound field control information generation unit 15. With the setting of the frequency characteristic, filtering process is performed for the decoded sound signal outputted from the sound decoder 12. With the filtering processing, sound, which is adjusted so as to catch the conversation easily, is outputted from the sound field adjustment unit 16.

The sound filtering processing is continued, until scene change is detected by the video scene change detection unit 13 and a current video scene is judged as a non-conversation scene by the video scene characteristic judging unit 14.

When the current video scene is judged as a non-conversation scene by the video scene characteristic judging unit 14, the sound field control information generation unit 15 generates sound filter information of a normal frequency characteristic as sound field control information. As a result, the sound field adjustment unit 16 performs normal filtering processing for the decoded sound outputted from the sound decoder 12.

According to the embodiment, the video scene characteristic judging unit 14 judges whether or not a conversation scene is included in a decoded image obtained from the video decoder 11. When the conversation scene is detected, the video scene characteristic judging unit 14 can automatically perform sound filtering processing of a frequency characteristic suiting to listening to the conversation for the decoded sound outputted from the sound decoder 12. With such a process, the conversation, which is displayed on a display unit to receive a video output, can be easy to listen to automatically.

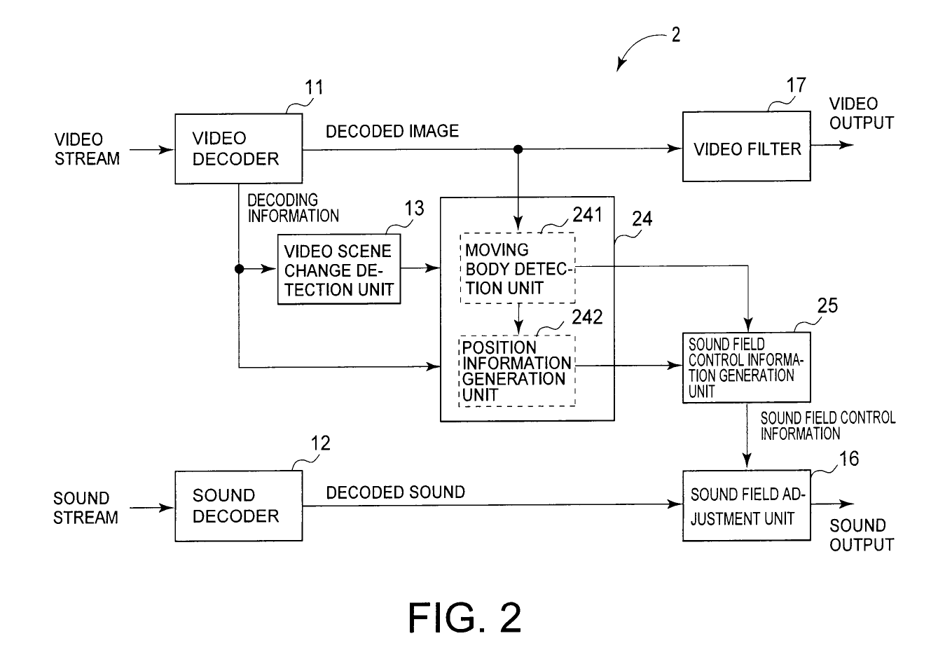

A second embodiment of a video-sound signal processing system according to the invention will be explained with reference to FIG. 2. FIG. 2 is a block diagram showing the configuration of the second embodiment.

According to the embodiment, images contained in video-sound contents are those of a moving body moving on a screen such as a car in a car race, and sound of the video-sound contents is monaural sound, for example.

The video-sound signal processing system of the embodiment adjusts the sound so as to emphasize the characteristic of the moving body, and moves a sound in accordance with the movement of the moving body, when a coded video stream and a coded sound stream of the video-sound contents are inputted. With the movement of the sound, the sound is as vivid as if one were present.

In FIG. 2, the same numerals as those shown in FIG. 1 indicate the same portions.

As shown in FIG. 2, a video-sound signal processing system 2 of the embodiment, similarly to the first embodiment, is provided with the video decoder 11, sound decoder 12, video scene change detection unit 13, sound field adjustment unit 16 and video filter 17. The video-sound signal processing system 2 is further provided with a video scene characteristic judging unit 24 and a sound field control information generation unit 25.

The video scene characteristic judging unit 24 receives output of the video scene change detection unit 13, decoding information and a decoded image signal from the video decoder 11. When scene change is detected by the video scene change detection unit 13, as will be described later, the video scene characteristic judging unit 24 identifies a characteristic of a current video scene. The output of the video scene characteristic judging unit 24 is provided to the sound field control information generation unit 25 to generate sound field control information.

The video scene characteristic judging unit 24 includes a moving body detection unit 241 and a position information generation unit 242. The moving body detection unit 241 detects the moving body from the decoded image. The position information generation unit 242 generates position information of the moving body on the basis of moving vector data being included in the decoding information, when the moving body detection unit 241 detects the moving body.

The moving body detection unit 241 compares pattern image data extracted from the decoded image with reference pattern data, which is prestored in the unit 24. The moving body detection unit 241 judges that a moving body having the reference pattern is detected. The reference pattern may be a pattern of a body such as a car, a train, or an airplane.

The moving body detection unit 241 generates moving body information relating to the kind of the moving body detected. The moving body detection unit 241 inputs the generated moving body information to the position information generation unit 242 and the sound field control information generation unit 25.

The position information generation unit 242 generates position information of the moving body on the basis of the moving vector data included in the decoding information, when the moving body detection unit 241 detects the moving body.

The video scene characteristic judging unit 24 judges that the characteristic of the current video scene is a moving scene of the moving body, when the moving body detection unit 241 detects the moving body. The video scene characteristic judging unit 24 outputs the moving body information generated by the moving body detection unit 241 and the position information generated by the position information generation unit 242 to the sound field control information generation unit 25.

The sound field control information generation unit 25 provides sound filter information and sound intensity information as sound control information to the sound field adjustment unit 16. The sound filter information is filter information to emphasize the characteristic of the moving body detected, on the basis of the moving body information relating to the kind of the moving body which is generated by the moving body detection unit 241. The sound filter information is information to emphasize the engine sound when the moving body is a car, for example.

Further, the sound intensity information is information to change balance of left and right sound intensities, on the basis of the position information generated by the position information generation unit 242.

The sound field adjustment unit 16 sets frequency characteristic of a sound filter provided in the sound field adjustment unit 16 according to the sound filter information outputted from the sound field control information generation unit 25. With the setting of the frequency characteristic, a filtering processing is performed for the decoded sound output from the sound decoder 12. As a result, a sound output is obtained to emphasize the characteristic of the moving body.

In addition, the sound field adjustment unit 16 changes the intensity of the sound based on the decoded sound signal outputted from the sound decoder 12, according to the sound intensity information outputted from the sound field control information generation unit 25. The sound field adjustment unit 16 changes the intensity of the left and right sounds of the sound output device such as a speaker.

In the second embodiment, similarly to the first embodiment, the sound field control information generation unit 25 changes the sound field control information to sound filter information of the normal frequency characteristic, when scene change is detected by the video scene change detection unit 13, and the video scene characteristic judging unit 24 judges that a moving body does not exist in a current video scene. With the change, the processing, which is performed for the decoded sound by the sound field adjustment unit 16, is changed to a normal filtering processing. Simultaneously, the balance of left and right sound intensities is set to a normal state.

According to the embodiment, the video scene characteristic judging unit 24 judges whether or not a moving body is included in the decoded video outputted from the video decoder 11. When the moving body is detected, sound filtering processing of emphasizing the characteristic of the moving body detected is performed for the decoded sound outputted from the sound decoder 12 automatically. Simultaneously, sound can be moved in accordance with the movement of the moving body displayed on the screen. Therefore, even in the case of monaural sound contents, a sound moves in accordance with the movement of the moving body displayed in the image so that a user can enjoy the sound as vivid as if he were present.

The video-sound signal processing systems 1, 2 of the above embodiments may be composed of one or a plurality of semiconductor chips. At least a part of the functions of the video-sound signal processing systems 1, 2 may be realized by software or a computer program.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A video-sound signal processing system, comprising:
a video decoder to decode a coded video stream, the video decoder outputting a decoded image signal and decoding information,
a sound decoder to decode a coded sound stream, the sound decoder outputting a decoded sound signal,
a video scene change detection unit to detect scene change between preceding and current video scenes on the basis of the decoding information obtained from the video decoder when the coded video stream is decoded by the video decoder,
a video scene characteristic judging unit to judge a characteristic of the current video scene from the decoded image signal outputted from the video decoder when starting of the current video scene is detected by the video scene change detection unit,
a sound field control information generation unit to generate sound field control information to control a sound field suiting to the current video scene according to the characteristic of the current video scene judged by the video scene characteristic judging unit, and
a sound field adjustment unit to adjust sound field of a sound based on the decoded sound signal outputted from the sound decoder, using the sound field control information outputted from the sound field control information generation unit.

2. A video-sound signal processing system according to claim 1, wherein the sound field control information generation unit generates sound filter information of a frequency characteristic suiting to listening to a sound produced by a specific body, as the sound field control information, when the video scene characteristic judging unit detects the specific body from the decoded image signal to judge that an image corresponding to the decoded video signal shows that the specific body exists.

3. A video-sound signal processing system according to claim 1,
wherein the video scene characteristic judging unit generates information of the moving body, and generates position information of the moving body on the basis of moving vector data being included in the decoding information outputted from the video decoder, when the moving body is detected from the decoded image signal, and
wherein the sound field control information generation unit generates sound filter information to emphasize sound of the moving body and sound intensity information to change balance of left and right sound intensities according to the position information, as the sound field control information, on the basis of the moving body information and the position information.

4. A video-sound signal processing system according to claim 1, wherein the video decoder, the sound decoder, the video scene change detection unit, the video scene characteristic judging unit, the sound field control information generation unit, and the sound field adjustment unit are composed of at least one semiconductor chip.

5. A video-sound signal processing system according to claim 1, wherein at least a part of functions of the video decoder, the sound decoder, the video scene change detection unit, the video scene characteristic judging unit, the sound field control information generation unit and the sound field adjustment unit is realized by software or a computer program.

6. A video-sound signal processing system according to claim 1, wherein the decoding information is information indicating that the picture type of the current video scene is I type specified in the moving image compression-coding standard H.264.

7. A video-sound signal processing system according to claim 1, wherein the decoding information is information indicating that moving vector value of the coded video stream varies for each macro-block of the coded video stream.

8. A video-sound signal processing system, comprising:
a video decoder to decode a coded video stream, the video decoder outputting a decoded image signal and decoding information,
a sound decoder to decode a coded sound stream, the sound decoder outputting a decoded sound signal,
a video scene change detection unit to detect scene change between preceding and current video scenes on the basis of the decoding information obtained from the video decoder when the coded video stream is decoded by the video decoder,
a video scene characteristic judging unit to judge whether talking exists or not from the decoded image signal outputted from the video decoder, when starting of the current video scene is detected by the video scene change detection unit, the video scene characteristic judging unit including a face detection portion and a talking detection portion, the face detection portion detecting a face of a person from the decoded image signal, further the talking detection portion detecting a movement of a mouth of the person from information of the face detected by the face detection portion for the judgment,
a sound field control information generation unit to generate sound field control information to control a sound field to suit to the current video scene according to the judgment of existence of talking by the video scene characteristic judging unit, and
a sound field adjustment unit to adjust the sound field of the sound the person corresponding the decoded sound signal outputted from the sound decoder, on the basis of the sound field control information outputted from the sound field control information generation unit.

9. A video-sound signal processing system according to claim 8, wherein the sound field control information generation unit generates sound filter information of a frequency characteristic suiting to listening to the talking, as the sound field control information.

10. A video-sound signal processing system according to claim 8, wherein the video decoder, the sound decoder, the video scene change detection unit, the video scene characteristic judging unit, the sound field control information generation unit and the sound field adjustment unit are composed of at least one semiconductor chip.

11. A video-sound signal processing system according to claim 8, wherein at least a part of functions of the video decoder, the sound decoder, the video scene change detection unit, the video scene characteristic judging unit, the sound field control information generation unit and the sound field adjustment unit is realized by software or a computer program.

12. A video-sound signal processing system according to claim 8, wherein the decoding information is information indicating that the picture type of the current video scene is I type specified in the moving image compression-coding standard H.264.

13. A video-sound signal processing system according to claim 8, wherein the decoding information is information indicating that moving vector value of the coded video stream varies for each macro-block of the coded video stream.

14. A video-sound signal processing system, comprising:
a video decoder to decode a coded video stream, the video decoder outputting a decoded image signal and decoding information,
a sound decoder to decode a coded sound stream, the sound decoder outputting a decoded sound signal,
a video scene change detection unit to detect scene change between preceding and current video scenes on the basis of the decoding information obtained from the video decoder when the coded video stream is decoded by the video decoder,
a video scene characteristic judging unit to detect a moving body from the decoded image signal outputted from the video decoder when starting of the current video scene is detected by the video scene change detection unit, the video scene characteristic judging unit including a moving body detection portion and a position information generation portion, the moving body detection portion detecting the moving body from the decoded image signal to generates information of the moving body, further the position information generation portion generating position information of the moving body on the basis of moving vector data being included in the decoded image signal outputted from the video decoder when the moving body detection portion detects the moving body,
a sound field control information generation unit to generate sound field control information to control sound field to suit to the current video scene according to the information of the moving body and the position information of the moving body, and
a sound field adjustment unit to adjust the sound field of the sound corresponding to the decoded sound signal outputted from the sound decoder, on the basis of the sound field control information outputted from the sound field control information generation unit.

15. A video-sound signal processing system according to claim 14, wherein the sound field control information generation unit generates sound filter information to emphasize sound of the moving body and sound intensity information to change balance of left and right sound intensities in response to the position information, as the sound field control information, in accordance with the information of the moving body and the position information of the moving body, respectively.

16. A video-sound signal processing system according to claim 14, wherein the video decoder, the sound decoder, the video scene change detection unit, the video scene characteristic judging unit, the sound field control information generation unit and the sound field adjustment unit are composed of at least one semiconductor chip.

17. A video-sound signal processing system according to claim 14, wherein at least a part of functions of the video decoder, the sound decoder, the video scene change detection unit, the video scene characteristic judging unit, the sound field control information generation unit and the sound field adjustment unit is realized by software or a computer program.

18. A video-sound signal processing system according to claim 14, wherein the decoding information is information indicating that the picture type of the current video scene is I type specified in the moving image compression-coding standard H.264.

19. A video-sound signal processing system according to claim 14, wherein the decoding information is information indicating that moving vector value of the coded video stream varies for each macro-block of the coded video stream.

20. A video-sound signal processing system according to claim 14, wherein the moving body is a car, a train, or an airplane.
